(19) United States
(12) Patent Application Publication
(10) Pub. No.: US 2016/0071662 A1
(43) Pub. Date: Mar. 10, 2016

(54) KEYBOARD SWITCH

(71) Applicant: Dongguan Zen-tech Electronic Technology Co., Ltd., Dongguan city (CN)

(72) Inventor: LIN CAI, Dongguan City (CN)

(21) Appl. No.: 14/846,999

(22) Filed: Sep. 7, 2015

(30) Foreign Application Priority Data
Sep. 5, 2014 (CN) 201420513690.6
Feb. 10, 2015 (CN) 201520096422.3
Feb. 11, 2015 (CN) 201520104943.9

(51) Int. Cl. H01H 13/14; H01H 13/02

(52) U.S. Cl. CPC H01H 13/14; H01H 13/023; H01H 2219/036; H01H 2205/002; H01H 2221/044; H01H 2219/062

(57) ABSTRACT

A keyboard switch includes a top cover, a pressing part, a spring, a bottom base, a fixed contact and a moving contact. The moving contact is provided with a first contact surface and two second contact surfaces of arched shape at two sides of the first contact surface. The fixed contact is provided with a third contact surface with at least two protruding portions formed thereon; the fixed contact is in contact with the first contact surface through the protruding portions. The pressing part is provided with an inclined surface corresponding to the second contact surfaces; when the pressing part is pressed to move downwardly, the inclined surface acts on the second contact surfaces and pushes the moving contact away from the fixed contact to cause the protruding portions to separate from the first contact surface.

### CROSS-REFERENCE TO RELATED APPLICATION

This application claims a priority to Chinese Patent Application No. 201420513690.6 filed on Sep. 5, 2014, Chinese Patent Application No. 201520096422.3 filed on Feb. 10, 2015, and Chinese Patent Application No. 201520104943.9 filed on Feb. 11, 2015, the disclosures of which are incorporated in their entireties by reference herein.

### TECHNICAL FIELD

The present disclosure relates to computer input devices, and more particularly to a keyboard switch, a mechanical keyboard and a keyboard.

### BACKGROUND

With the development of communication technology, more and more electronic products such as computers and mobile phones appear in people's life and work. When using a computer, an input device such as a keyboard is usually used.

According to working principles and buttons, keyboards can be divided into four types including: mechanical keyboard, plastic film keyboard, conductive rubber keyboard and contactless electrostatic capacitive keyboard. In a mechanical keyboard, each key includes a switch for controlling between a closed state and an open state. Thus, the key may also be referred as keyboard switch.

An existing keyboard switch includes a bottom base, a top cover, a pressing part, a fixed contact and a moving contact. One contact point is provided on a middle position of the fixed contact. The fixed contact is in contact with the moving contact through the contact point. However, when using the keyboard switch, if the moving contact is slightly offset, the moving contact cannot contact the contact point of the fixed contact, thereby greatly reducing service life of the keyboard.

Further, a mechanical keyboard is easily damaged by water or other liquid entering into the keyboard, this is because it is very difficult to discharge the water or other liquid entering into the keyboard and a contact position between a fixed contact and a moving contact is easily contaminated, thereby easily causing a failure or damage of the keyboard.

Moreover, in the existing keyboard, letters and numbers on keyboard switches can be seen clearly only when there is a strong environmental light; when there is no environmental light or the environmental light is not strong, the letters and numbers cannot be clearly identified, thereby adversely affecting user experience.

### SUMMARY

In view of this, one embodiment of the present disclosure provides a keyboard switch, which can solve the problem of bad contact and short service life in the related art.

One embodiment of the present disclosure further provides a keyboard switch and a mechanical keyboard, which can solve the problem existing in the related art that it is very difficult to discharge the water or other liquid entering into the keyboard switch.

One embodiment of the present disclosure further provides a keyboard switch and a mechanical keyboard, which can solve the problem in the related art that the letters and numbers on keys cannot be clearly identified when there is no light or the light is not strong.

One embodiment of the present disclosure provides a keyboard switch including a top cover, a pressing part, a spring, a bottom base, a fixed contact and a moving contact; wherein the moving contact is installed on the bottom base and a weld leg of the moving contact is extended through the bottom base; the fixed contact is installed on the bottom base and a weld leg of the fixed contact is extended through the bottom base; the moving contact and the fixed contact are disposed at opposing positions; wherein one end of the spring is in contact with the bottom base, and the other end of the spring is in contact with the pressing part; one opening is defined in the top cover; the pressing part is extended through the opening of the top cover; the top cover is assembled to the bottom base; wherein the moving contact is provided with a first contact surface and two second contact surfaces of arched shape at two sides of the first contact surface; the fixed contact is provided with a third contact surface with at least two protruding portions formed thereon; the at least two protruding portions of the fixed contact is in contact with the first contact surface of the moving contact; the pressing part is provided with an inclined surface corresponding to the second contact surfaces of the moving contact; when the pressing part is pressed to move downwardly, the inclined surface of the pressing part acts on the second contact surfaces of the moving contact and pushes the moving contact away from the fixed contact to cause the at least two protruding portions of the third contact surface to separate from the first contact surface of the moving contact.

In this embodiment, at least two protruding portions are provided on the third contact surface of the fixed contact, and the third contact surface is in contact with the first contact surface through one or two of the protruding portions, which can effectively increase a contact surface area between the fixed contact and the moving contact, thereby improving service life of the keyboard switch.

In order to solve the problem existing in the related art that it is very difficult to discharge the water or other liquid entering into the keyboard switch, one embodiment of the present disclosure provides a keyboard switch including a top cover, a pressing part, a spring, a bottom base, a fixed contact and a moving contact; wherein the moving contact is installed on the bottom base and a weld leg of the moving contact is extended through the bottom base; the fixed contact is installed on the bottom base and a weld leg of the fixed contact is extended through the bottom base; the moving contact and the fixed contact are disposed at opposing positions; wherein one end of the spring is in contact with the bottom base, and the other end of the spring is in contact with the pressing part; one opening is defined in the top cover; the pressing part is extended through the opening of the top cover; the top cover is assembled to the bottom base; wherein the bottom base is provided with at least one first through hole for discharging water or other liquid entering into the keyboard switch.

In order to solve the problem in the related art that the letter or number keys cannot be clearly identified when there is no light or the light is not strong, one embodiment of the present disclosure further provides a keyboard switch including a top cover, a pressing part, a spring, a bottom base, a fixed contact and a moving contact; wherein the moving contact is installed on the bottom base and a weld leg of the moving contact is extended through the bottom base; the fixed contact is installed on the bottom base and a weld leg of the fixed contact is extended through the bottom base; the moving contact and the fixed contact are disposed at opposing positions; wherein one end of the spring is in contact with the bottom base, and the other end of the spring is in contact with the pressing part; one opening is defined in the top cover; the pressing part is extended through the opening of the top cover; the top cover is assembled to the bottom base; wherein the top cover is provided with a light guide pillar, the bottom base is provided with a receiving hole, the light guide pillar is located above and in alignment with the receiving hole, the receiving hole is used to receive a light source therein.

### BRIEF DESCRIPTION OF THE DRAWINGS

FIG. 1 is a perspective view of a keyboard switch according to a first embodiment of the present disclosure;

FIG. 2 is a sectional view of the keyboard switch of FIG. 1 according to the first embodiment of the present disclosure;

FIG. 3 is an exploded view of the keyboard switch of FIG. 1 according to the first embodiment of the present disclosure;

FIG. 4 is a schematic view of a fixed contact of the keyboard switch of FIG. 1 according to the first embodiment of the present disclosure;

FIG. 5 is a schematic view of a moving contact of the keyboard switch of FIG. 1 according to the first embodiment of the present disclosure;

FIG. 6 is a perspective view of a keyboard switch according to a second embodiment of the present disclosure as viewed from a bottom view angle;

FIG. 7 is a perspective view of the keyboard switch of FIG. 6 according to the second embodiment of the present disclosure as viewed from a top view angle;

FIG. 8 is an exploded view of a keyboard switch according to a third embodiment of the present disclosure;

FIG. 9 is a perspective view of the keyboard switch of FIG. 8 according to the third embodiment of the present disclosure as viewed from a bottom view angle;

FIG. 10 is a bottom plan view of the keyboard switch of FIG. 9 according to the third embodiment of the present disclosure;

FIG. 11 is an exploded view of a keyboard switch according to a fourth embodiment of the present disclosure;

FIG. 12 is similar to FIG. 9, but further showing a circuit board with an LED.

### DETAILED DESCRIPTION

To make technical problems to be solved, technical solutions and advantages more clearly, detailed description will be given below in conjunction the accompanying drawings and embodiments.

### First Embodiment

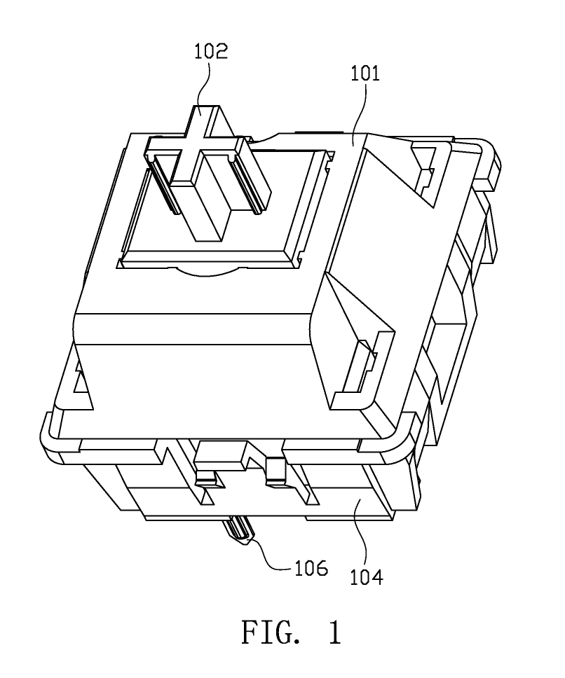

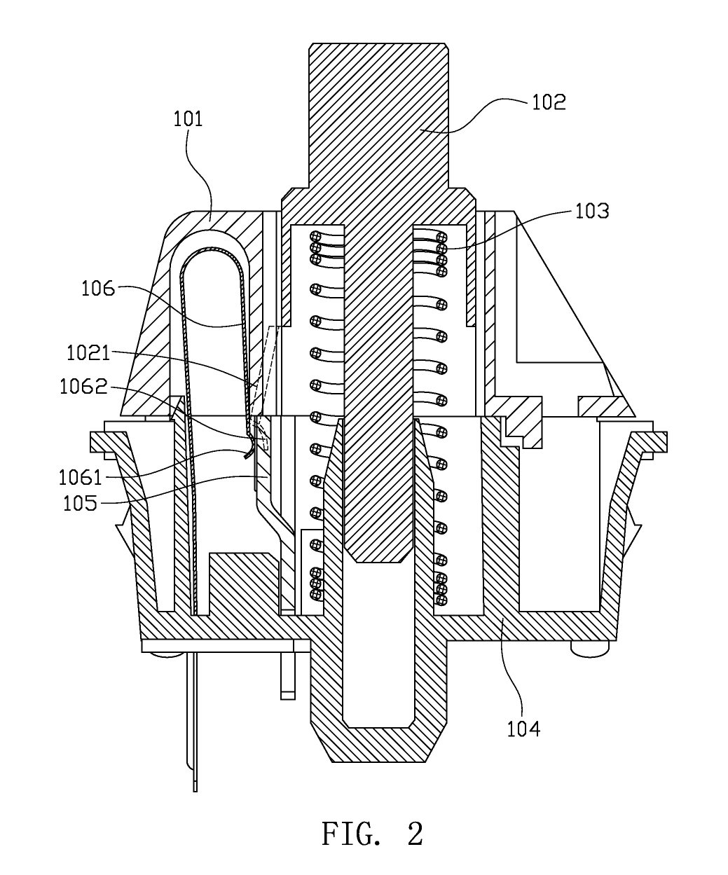

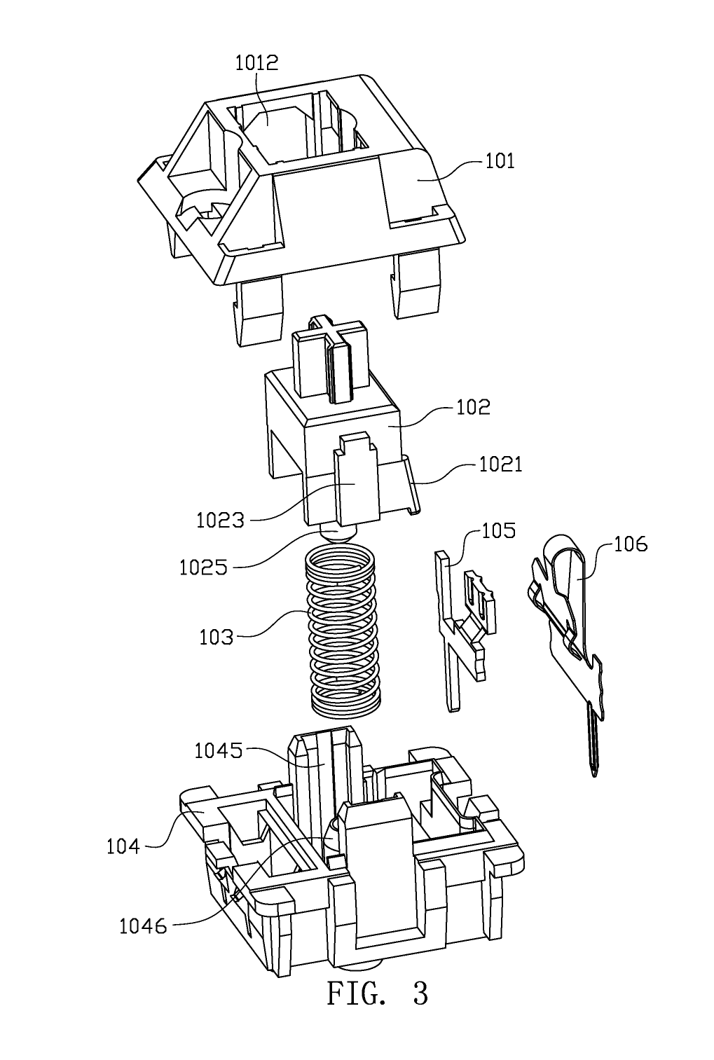

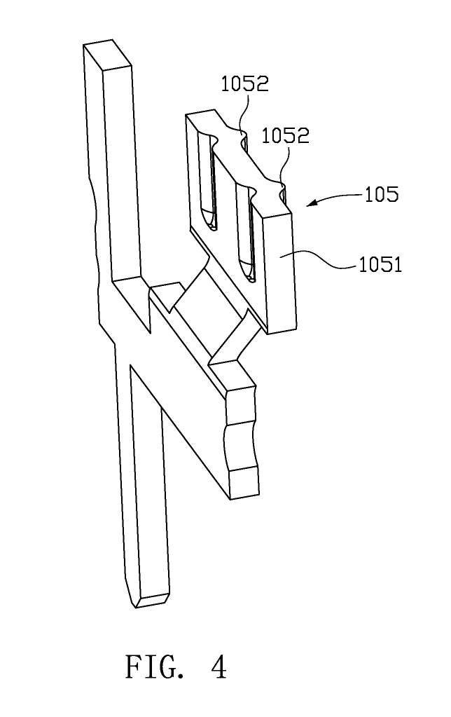

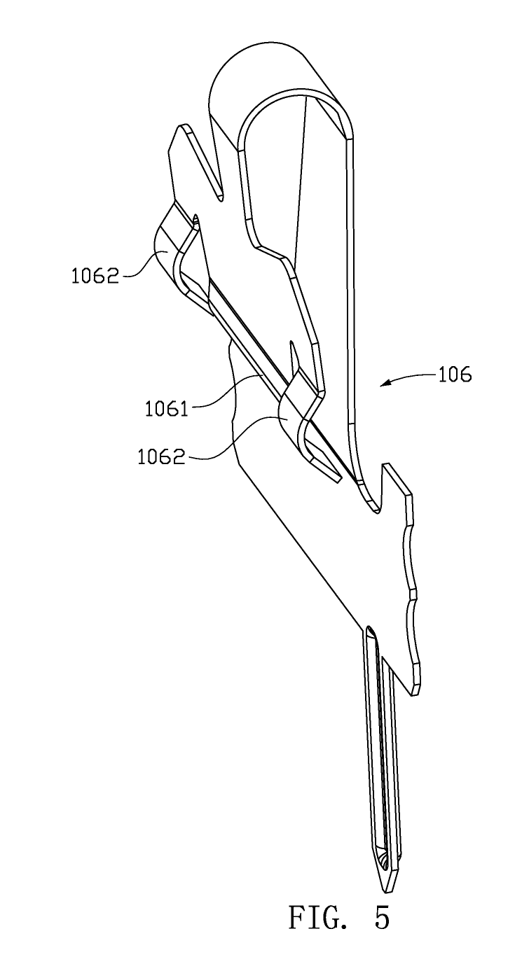

Referring to FIGS. 1-5, FIG. 1 is a perspective view of a keyboard switch according to a first embodiment of the present disclosure; FIG. 2 is a sectional view of the keyboard switch of FIG. 1 according to the first embodiment of the present disclosure; FIG. 3 is an exploded view of the keyboard switch of FIG. 1 according to the first embodiment of the present disclosure; FIG. 4 is a schematic view of a fixed contact of the keyboard switch of FIG. 1 according to the first embodiment of the present disclosure; and FIG. 5 is a schematic view of a moving contact of the keyboard switch of FIG. 1 according to the first embodiment of the present disclosure.

In the first embodiment, the keyboard switch includes a top cover 101, a pressing part 102, a spring 103, a bottom base 104, a fixed contact 105, and a moving contact 106. The top cover 101 is mounted to the bottom base 104. The spring 103, the fixed contact 105 and the moving contact 106 are received between the top cover 101 and the bottom base 104. A hollow sleeve 1046 is provided in the middle of the bottom base 104 and protrudes upwardly towards the top cover 101. The spring 103 is mounted around the hollow sleeve 1046 of the bottom base 104. The pressing part 102 extends through the top cover 101 and is movably installed on the bottom base 104. An upper portion of the pressing part 102 protrudes outwards from the top surface of the top cover 101 for being pressed.

The moving contact 106 is installed on the bottom base 104. A weld leg of the moving contact 106 is extended outwards through the bottom base 104. The fixed contact 105 is installed on the bottom base 104. A weld leg of the fixed contact 105 is extended outwards through the bottom base 104. The moving contact 106 and the fixed contact 105 are disposed at opposing positions.

One end of the spring 103 abuts against the bottom base 104, and the other end of the spring 103 abuts against the pressing part 102. An opening 1012 is defined in the top surface of the top cover 101. The pressing part 102 extends through the opening 1012 of the top cover 101 and is movable in the opening 1012 along a vertical direction. The top cover 101 is assembled to the bottom base 104 by means of clamping.

The moving contact 106 is provided with a first contact surface 1061 and two second contact surfaces 1062 formed at two sides of the first contact surface 1061. The second contact surfaces 1062 have an arched shape, and are arched towards the fixed contact 105.

The fixed contact 105 is provided with a third contact surface 1051 with two protruding ribs 1052 formed thereon towards the moving contact 106. The fixed contact 105 is in contact with the first contact surface 1061 through one or two of the protruding ribs 1052 at a first position.

The pressing part 102 is provided with an inclined surface 1021 corresponding to the second contact surfaces 1062 of the moving contact 106. The inclined surface 1021 is used to press the second contact surfaces 1062. When the pressing part 102 is pressed to move downwardly, the inclined surface 1021 acts on the second contact surfaces 1062 of the moving contact 106 and pushes the moving contact 106 away from the fixed contact 105 to cause the protruding ribs 1052 of the third contact surface 1051 of the fixed contact 105 to separate from the first contact surface 1061 of the moving contact 106 at a second position. That is, at the second position, the protruding ribs 1052 is not in contact with the first contact surface 1061.

It should be noted, the number of the protruding ribs 1052 provided on the third contact surface 1051 of the fixed contact 105 may be at least two, such as two, three or four. Further, the protruding ribs 1052 provided on the third contact surface 1051 may be parallel to each other, or non-parallel to each other. In actual applications, the number and positions of the protruding ribs 1052 provided on the third contact surface 1051 may be set according to needs.

It should be noted, in the first embodiment, the keyboard switch is described by taking the protruding ribs 1052 provided on the third contact surface 1051 as an example. Instead of the protruding ribs 1052, two protruding bumps or other protruding structures may be provided on the third contact surface 1051. The third contact surface 1051 of the fixed contact 105 effectively increases a contact area with the first contact surface 1061 of the moving contact 106, thereby improving service life of the keyboard switch.

It should be noted, the first contact surface 1061 of the moving contact 106 may also be of an arched shape. An arch height of the first contact surface 1061 is lower than an arch height of the second contact surface 1062.

In the first embodiment, the first contact surface 1061, the second contact surface 1062 and the third contact surface 1051 are preferably made of copper. For example, the first contact surface 1061, the second contact surface 1062 and the third contact surface 1051 each may be a copper layer.

In the first embodiment, the bottom base 104 is provided with the hollow sleeve 1046, and one end of the spring 103 is sleeved on an outer periphery of the hollow sleeve 1046 and is in contact with the bottom base 104. The pressing part 102 is provided with a post 1025 in alignment with the hollow sleeve 1046. The post 1025 extends downwards from the pressing part 102 towards the hollow sleeve 1046. The other end of the spring 103 is sleeved on an outer periphery of the post 1025 and is in contact with the pressing part 102. That is, the spring 103 is sandwiched between the bottom base 104 and the pressing part 102. The hollow sleeve 1046 has an inner diameter lager than an outer diameter of the post 1025. A bottom portion of the post 1025 is movably received in the hollow sleeve 1046.

In the first embodiment, two vertical sliding blocks 1023 are provided on two opposite sides of the pressing part 102, and two sliding grooves 1045 are provided in the bottom base 104 and match the sliding blocks 1023, so that the sliding blocks 1023 of the pressing part 102 can be held in the sliding grooves 1045 and move up and downward along the sliding grooves 1045.

In the first embodiment, when the keyboard switch is in an unused state, the protruding ribs 1052 on the third contact surface 1051 of the fixed contact 105 are in contact with the first contact surface 1061 of the moving contact 106 to form a closing state at the first position. When the pressing part 102 is pressed downwardly, the pressing part 102 is moved downwardly. With the downward movement of the pressing part 102, the inclined surface 1021 of the pressing part 102 contacts and presses the second contact surfaces 1062 of the moving contact 106. Since the moving contact 106 is flexible, the first contact surface 1061 of the moving contact 106 is urged by the inclined surface 1021 of the pressing part 102 to be separated from the protruding ribs 1052 of the third contact surface 1051 of the fixed contact 105 to form an open state at the second position. Further, since the spring 103 has elasticity, the spring 103 is compressed to produce an elastic force when the pressing part 102 is moved downwardly. When the force applied on the pressing part 102 disappears, the pressing part 102 is moved upwardly under action of the elastic force of the spring 103, so that the inclined surface 1021 is gradually moved away from the second contact surfaces 1062 and the moving contact 106 returns to its original position with the first contact surface 1061 in contact with the protruding ribs 1052 of the third contact surface 1051, i.e., returning to the first position.

In the embodiment, at least two protruding structures such as ribs 1052 or bumps are provided on the third contact surface 1051 of the fixed contact 105, and the fixed contact 105 is in contact with the first contact surface 1061 of the moving contact 106 through one or two of the protruding structures 1052, which effectively increases a contact surface area between the third contact surface 1051 and the first contact surface 1061, thereby improving service life of the keyboard switch. In this embodiment, the keyboard switch shown in FIGS. 1-5 can be applied to a mechanical keyboard. That is, each key of the mechanical keyboard can adopt the keyboard switch shown in FIGS. 1-5 of the present disclosure.

### Second Embodiment

This embodiment provides a keyboard switch and a mechanical keyboard, which can solve the problem existing in the related art that it is very difficult to discharge the water or other liquid entering into the keyboard switch.

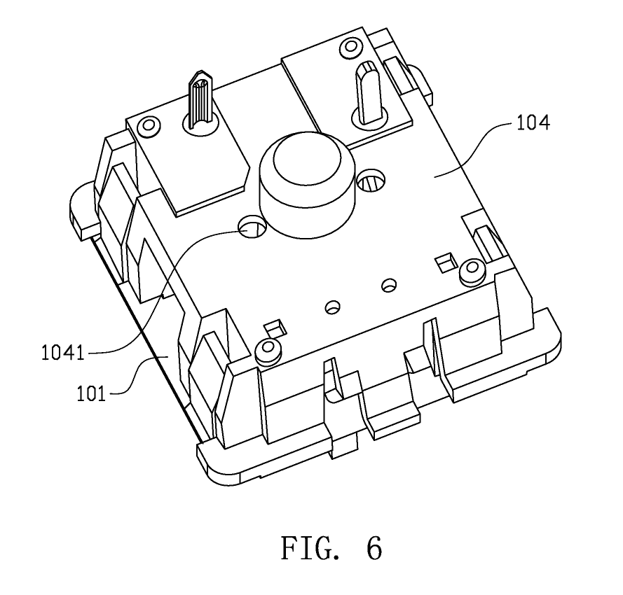

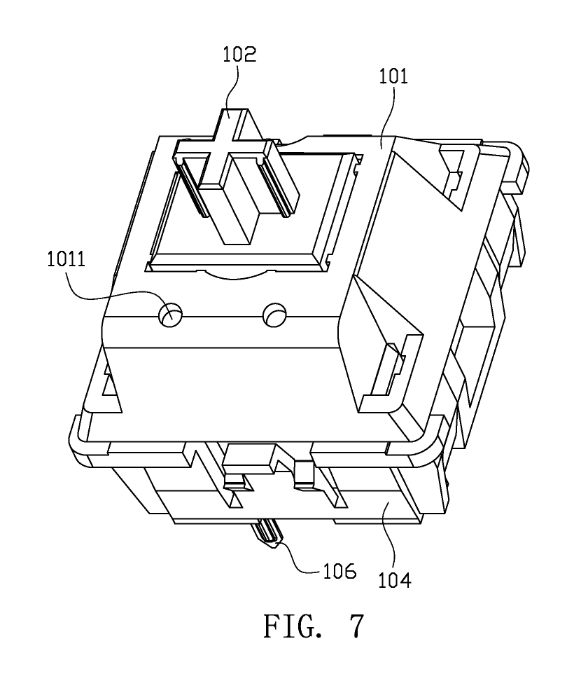

Referring to FIG. 3 and FIGS. 6-7, FIG. 6 is a perspective view of a keyboard switch according to a second embodiment of the present disclosure as viewed from a bottom view angle; FIG. 7 is a perspective view of the keyboard switch of FIG. 6 according to the second embodiment of the present disclosure as viewed from a top view angle.

A keyboard switch in this embodiment is similar to the keyboard switch shown in FIGS. 1-5. For example, the keyboard switch also includes a top cover 101, a pressing part 102, a spring 103, a bottom base 104, a fixed contact 105 and a moving contact 106. The moving contact 106 is installed on the bottom base 104. A weld leg of the moving contact 106 is extended through the bottom base 104. The fixed contact 105 is installed on the bottom base 104. A weld leg of the fixed contact 105 is extended through the bottom base 104. The moving contact 106 and the fixed contact 105 are disposed at opposing positions. One end of the spring 103 is in contact with the bottom base 104, and the other end of the spring 103 is in contact with the pressing part 102. An opening 1012 is defined in the top cover 101. The pressing part 102 is extended through the opening 1012 of the top cover 101. The top cover 101 is assembled to the bottom base 104 by means of clamping.

The bottom base 104 is provided with at least one first through hole 1041. The first through hole 1041 is defined in a bottom surface of the bottom base 104, so that water or other liquid entering into the keyboard switch can be discharged away from the first through hole 1041 of the bottom base 104, which can effectively avoid the problem of failure or damage of the keyboard switch caused by the water or other liquid entering into the keyboard switch which cannot be discharged and is in the keyboard switch for a long time.

In this embodiment, the top cover 101 is provided with at least one second through hole 1011. The second through hole 1011 may be defined in a top surface of the top cover 101. The presence of the first through hole 1041 in the bottom base 104 and the second through hole 1011 in the top cover 101 can enable an interior of the keyboard switch to be communicated with outside space, so that air pressures inside and outside of the keyboard switch can be balanced, thereby avoiding a siphon phenomenon caused by instantaneous vacuum generated during a movement that the pressing part 102 is moved quickly upward and downwardly. Further, even if water or other liquid enters into the keyboard switch through the second through hole 1011 of the top cover 101, water or other liquid can quickly flow out from the first through hole 1041 of the bottom base 104.

In this embodiment, by the presence of the first through hole 1041 of the bottom base 104 and the second through hole 1011 of the top cover 101, the keyboard switch can be directly cleaned without being disassembled. Specifically, cleaning agent may be injected through the second through hole 1011 of the top cover 101, and the cleaning agent may be directly applied around the fixed contact 105 and the moving contact 106 for cleaning. Dirty water can flow out from the first through hole 1041 of the bottom base 104. This can effectively reduce operation difficulty and improve cleaning efficiency, without having to disassembling the mechanical keyboard for cleaning.

It should be noted, the “first” and “second” in the “first through hole 1041” and the “second through hole 1011” are merely used to distinguish through holes in different modules, and are not used to limit the through holes themselves.

In this embodiment, the keyboard switch includes the top cover 101, the pressing part 102, the spring 103, the bottom base 104, the fixed contact 105 and the moving contact 106. The moving contact 106 is installed on the bottom base 104. The weld leg of the moving contact 106 is extended through the bottom base 104. The fixed contact 105 is installed on the bottom base 104. The weld leg of the fixed contact 105 is extended through the bottom base 104. The moving contact 106 and the fixed contact 105 are disposed at opposing positions. One end of the spring 103 is in contact with the bottom base 104, and the other end of the spring 103 is in contact with the pressing part 102. One opening 1012 is defined in the top cover 101. The pressing part 102 is extended through the opening 1012 of the top cover 101. The top cover 101 is assembled to the bottom base 104 by means of clamping. The bottom base 104 is provided with at least one first through hole 1041, so that water or other liquid entering into the keyboard switch can be discharged from the first through hole 1041 of the bottom base 104, which can effectively avoid the problem of failure or damage of the keyboard switch caused by the water or other liquid entering into the keyboard switch which cannot be discharged and is in the keyboard switch for a long time. Further, the top cover 101 is provided with at least second through hole 1011, so as to enable an interior of the keyboard switch to be communicated with outside space, so that air pressures inside and outside of the keyboard switch can be balanced, thereby avoiding a siphon phenomenon caused by instantaneous vacuum generated when the pressing part 102 is moved quickly upward and downwardly. The presence of the first through hole 1041 of the bottom base 104 and the second through hole 1011 of the top cover 101 can effectively reduce operation difficulty and improve cleaning efficiency, without having to disassembling the mechanical keyboard for cleaning.

In this embodiment, the keyboard switch shown in FIGS. 6-7 can be applied to a mechanical keyboard. That is, each key of the mechanical keyboard can adopt the keyboard switch shown in FIGS. 6-7 of the present disclosure.

### Third Embodiment and Fourth Embodiment

The two embodiments provide a keyboard switch and a mechanical keyboard, which can solve the problem in the related art that the letters and numbers on keys cannot be clearly identified when there is no light or the light is not strong.

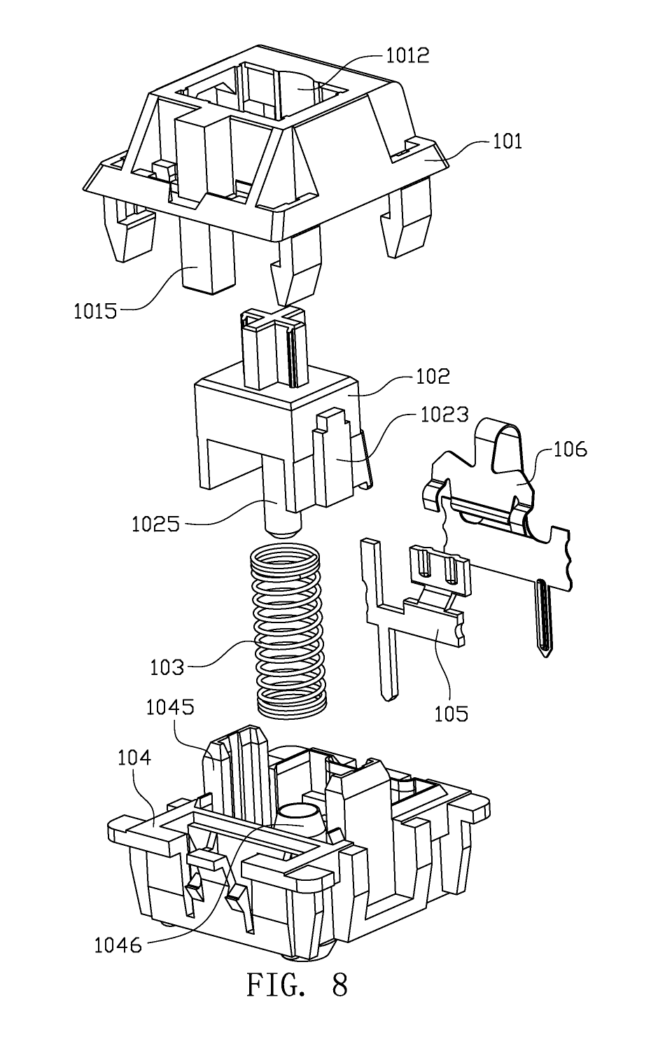

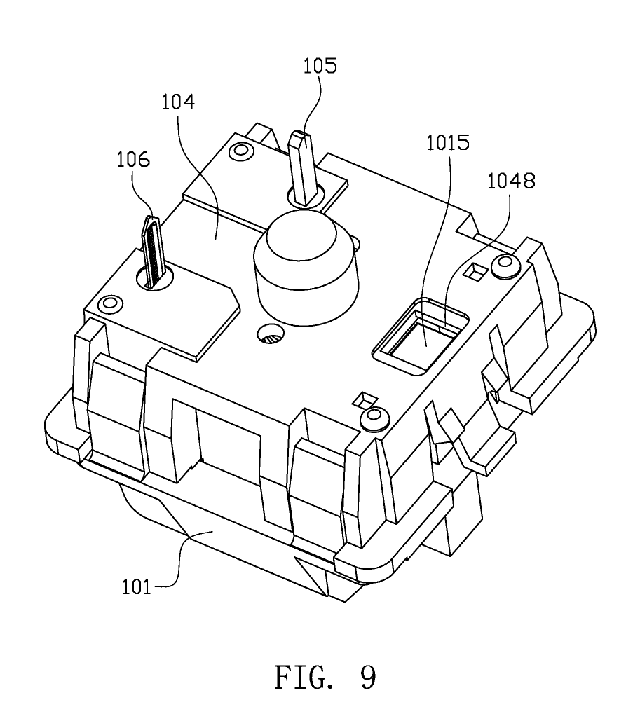

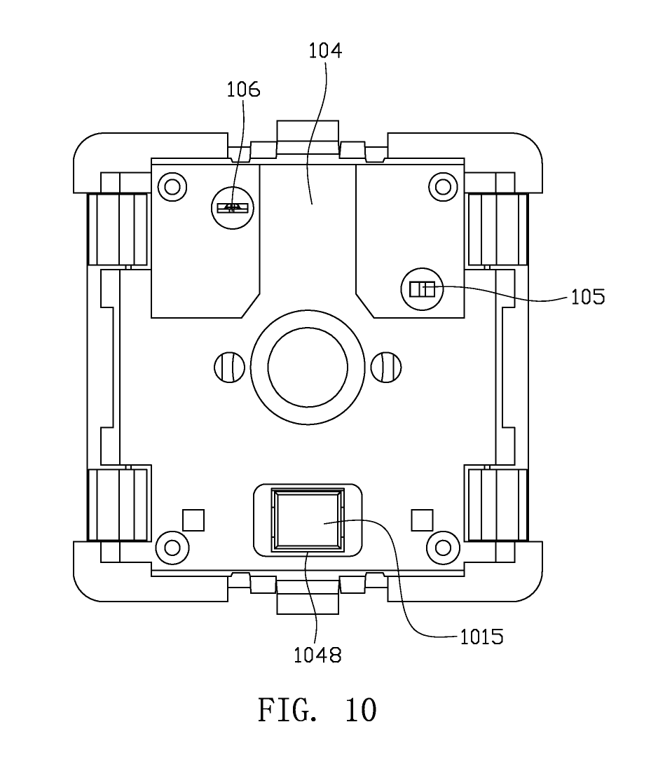

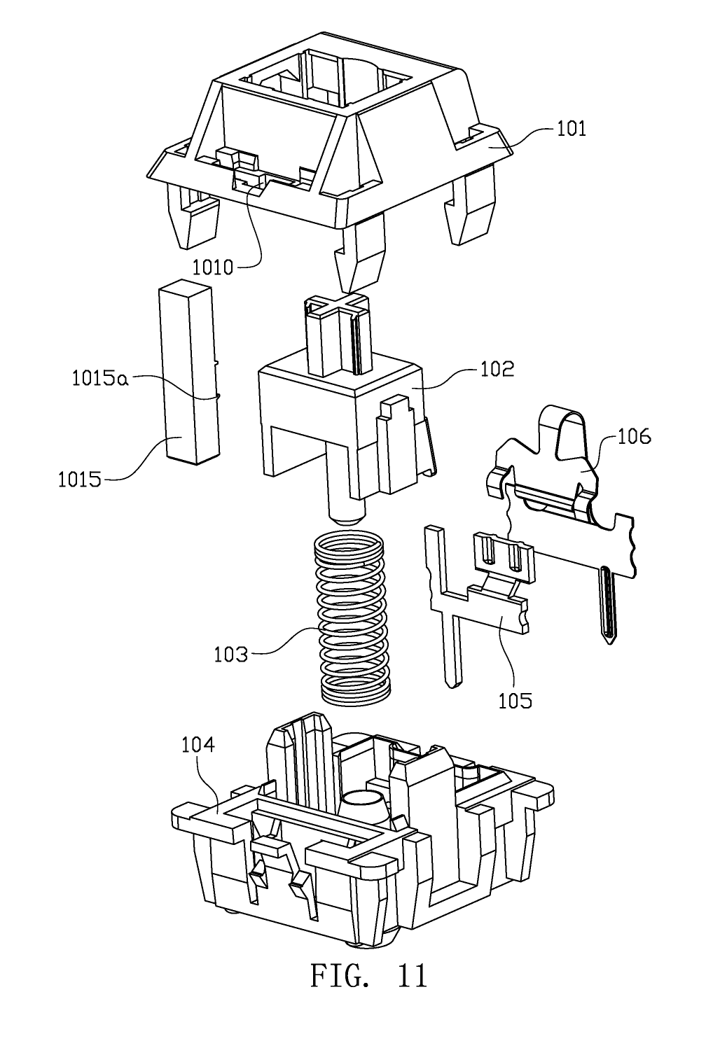

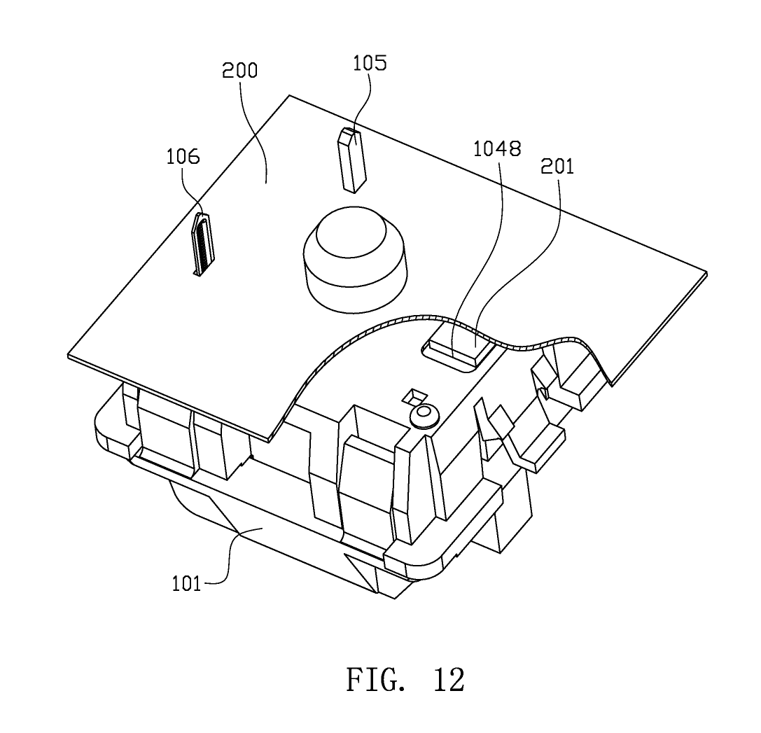

Referring to FIGS. 8-10, FIG. 8 is an exploded view of a keyboard switch according to a third embodiment of the present disclosure; FIG. 9 is a perspective view of the keyboard switch of FIG. 8 according to the third embodiment of the present disclosure as viewed from a bottom view angle; FIG. 10 is a bottom plan view of the keyboard switch of FIG. 9 according to the third embodiment of the present disclosure; FIG. 11 is an exploded view of a keyboard switch according to a fourth embodiment of the present disclosure; FIG. 12 is similar to FIG. 9, but further showing a circuit board with an LED.

A keyboard switch in the embodiments is similar to the keyboard switch shown in FIGS. 1-5, for example, the keyboard switch also includes a top cover 101, a pressing part 102, a spring 103, a bottom base 104, a fixed contact 105 and a moving contact 106. The moving contact 106 is installed on the bottom base 104. A weld leg of the moving contact 106 is extended through the bottom base 104. The fixed contact 105 is installed on the bottom base 104. A weld leg of the fixed contact 105 is extended through the bottom base 104. The moving contact 106 and the fixed contact 105 are disposed at opposing positions. One end of the spring 103 is in contact with the bottom base 104, and the other end of the spring 103 is in contact with the pressing part 102. An opening 1012 is defined in the top cover 101. The pressing part 102 is extended through the opening 1012 of the top cover 101. The top cover 101 is assembled to the bottom base 104 by means of clamping.

The top cover 101 further includes a light guide pillar 1015. The bottom base 104 is provided with an LED receiving hole 1048. The light guide pillar 1015 is located above and in alignment with the LED receiving hole 1048. The LED receiving hole 1048 is used to receive a light source such as an SMT LED 201 (shown in FIG. 12) therein. The light guide pillar 1015 is used to guide light emitted from the light source 201.

In the embodiments, the light guide pillar 1015 may be integrally formed with the top cover 101; or, the light guide pillar 1015 and the top cover 101 may be separate detachable structures. For example, as shown in FIG. 8, the top cover 101 is integrally formed with the top cover 101. For example, as shown in FIG. 11, the top cover 101 is provided with an insertion groove 1010 and the light guide pillar 1015 may be detachably inserted into the insertion groove 1010. In one embodiment, the light guide pillar 1015 may also have an interference with the insertion groove 1010. In addition, the light guide pillar 1015 may be further provided with at least one hook 1015a; when the light guide pillar 1015 is inserted into the insertion groove 1010, the hook 1015a can engage with a bottom of the top cover 101, thereby preventing the light guide pillar 1015 from escaping from the insertion groove 1010 due to incorrect operations or other undesired reasons.

In actual applications, whether the light guide pillar 1015 is integrally formed with the top cover 101 or not may be determined according to needs.

The light guide pillar 1015 is located at an edge of the top cover 101, and the receiving hole 1048 is also located in an edge of the bottom base 104 so that the receiving hole 1048 is located below and in alignment with the light guide pillar 1015. In actual applications, the position of the light guide pillar 1015 at the top cover 101 can be determined according to needs, as long as the receiving hole 1048 of the bottom base 104 is located below and in alignment with the light guide pillar 1015.

In the embodiments, the light guide pillar 1015 is made of transparent material such as PC (Polycarbonate), so that the light guide pillar 1015 has good light transmittance. Color of the light guide pillar 1015 may be determined according to needs, for example, red or black.

In the embodiments, the top cover 101 may also be transparent. That is, the top cover 101 may be made of transparent material such as PC.

In actual applications, the light guide pillar 1015 is made of transparent material, and the top cover 101 is made of opaque material; alternatively, the light guide pillar 1015 is made of transparent material, and the top cover 101 is also made of transparent material. When both of the light guide pillar 1015 and the top cover 101 are made of transparent material, the light guide pillar 1015 and the top cover 101 may be integrally formed.

In the embodiments, the keyboard switch can be applied in a key of n keyboard; that is, at least one key of the keyboard can adopt the keyboard switch of FIGS. 8-12. An SMT LED 201 can be provided on a bottom base 104 of the keyboard switch in such a manner that the SMT LED 201 is located in the LED receiving hole 1048 of the keyboard switch.

As shown in the embodiment of FIG. 12, a circuit board 200 is provided for the keyboard adopting the keyboard switches, and SMT LEDs 201 are arranged on the circuit board 200. The SMT LEDs 201 are arranged corresponding to the keyboard switches, and the SMT LEDs 201 are located in the LED receiving holes 1048 of the corresponding keyboard switches. By the presence of the SMT LEDs 201, the process of assembling the keyboard can be effectively simplified when comparing with using pin type LEDs, cost and workload can be reduced.

In the embodiments, by the presence of the light guide pillar 1015 on the top cover 101 and the LED receiving hole 1048 in the bottom base 104 in such a manner that the light guide pillar 1015 is located above and in alignment with the receiving hole 1048, the SMT LED 201 is received and located in the LED receiving hole 1048, and light emitted from the SMT LED 201 can be guided by the light guide pillar 1015 and evenly distributed to make the number or letter keys on the keyboard to be seen clearer, thereby improving user experience. The SMT LED 201 enables the keyboard switch to emit light so as to light up the number or letter keys on the keyboard. Further, by the presence of the light guide pillar 1015, light emitted from the LED 201 can be accumulated and uniformly distributed at the keyboard switch, the light is more uniform, the number and letter keys are more clearer, and the user experience is improved.

The above are merely optional embodiments of the present disclosure. It should be appreciated that, a person skilled in the art may make further modifications and improvements without departing from the principle of the present disclosure, and these modifications and improvements shall also fall within the scope of the present disclosure.

What is claimed is:

1. A keyboard switch comprising a top cover, a pressing part, a spring, a bottom base, a fixed contact and a moving contact;
wherein the moving contact is installed on the bottom base and a weld leg of the moving contact is extended through the bottom base; the fixed contact is installed on the bottom base and a weld leg of the fixed contact is extended through the bottom base; the moving contact and the fixed contact are disposed at opposing positions;
wherein one end of the spring is in contact with the bottom base, and the other end of the spring is in contact with the pressing part; one opening is defined in the top cover; the pressing part is extended through the opening of the top cover; the top cover is assembled to the bottom base;
wherein the moving contact is provided with a first contact surface and two second contact surfaces of arched shape at two sides of the first contact surface;
the fixed contact is provided with a third contact surface with at least two protruding portions formed thereon; the at least two protruding portions of the fixed contact is in contact with the first contact surface of the moving contact;
the pressing part is provided with an inclined surface corresponding to the second contact surfaces of the moving contact; when the pressing part is pressed to move downwardly, the inclined surface of the pressing part acts on the second contact surfaces of the moving contact and pushes the moving contact away from the fixed contact to cause the at least two protruding portions of the third contact surface of the fixed contact to separate from the first contact surface of the moving contact.

2. The keyboard switch according to claim 1, wherein the first contact surface, the second contact surface and the third contact surface are made of copper.

3. The keyboard switch according to claim 1, wherein the bottom base is provided with a hollow sleeve, the pressing part is provided with a post in alignment with the hollow sleeve, the hollow sleeve has an inner diameter lager than an outer diameter of the post, a bottom portion of the post is movably located in the hollow sleeve, the spring is sleeved on the hollow sleeve and the post, two ends of the spring abut against the pressing part and the bottom base, respectively.

4. The keyboard switch according to claim 3, wherein two sliding blocks are provided on two opposite sides of the pressing part, and two sliding grooves are provided in the bottom base and match the sliding blocks; the sliding blocks of the pressing part are held in the sliding grooves and move up and downward in the sliding grooves.

5. The keyboard switch according to claim 1, wherein the bottom base is provided with at least one first through hole for discharging water or other liquid entering into the keyboard switch.

6. The keyboard switch according to claim 5, wherein the top cover is provided with at least one second through hole, the at least one second through hole is defined in a top surface of the top cover, the at least one first through hole is defined in a bottom surface of the bottom base.

7. The keyboard switch according to claim 1, wherein the top cover is provided with a light guide pillar, the bottom base is provided with a receiving hole, the light guide pillar is located above and in alignment with the receiving hole, the receiving hole is used to receive a light source therein.

8. The keyboard switch according to claim 7, wherein the light guide pillar is integrally formed with the top cover.

9. The keyboard switch according to claim 7, wherein the light guide pillar and the top cover are separate detachable structures.

10. A keyboard switch comprising a top cover, a pressing part, a spring, a bottom base, a fixed contact and a moving contact;
wherein the moving contact is installed on the bottom base and a weld leg of the moving contact is extended through the bottom base; the fixed contact is installed on the bottom base and a weld leg of the fixed contact is extended through the bottom base; the moving contact and the fixed contact are disposed at opposing positions;
wherein one end of the spring is in contact with the bottom base, and the other end of the spring is in contact with the pressing part; one opening is defined in the top cover; the pressing part is extended through the opening of the top cover; the top cover is assembled to the bottom base;
wherein the bottom base is provided with at least one first through hole for discharging water or other liquid entering into the keyboard switch.

11. The keyboard switch according to claim 10, wherein the top cover is provided with at least one second through hole, the at least one second through hole is defined in a top surface of the top cover, the at least one first through hole is defined in a bottom surface of the bottom base.

12. The keyboard switch according to claim 10, wherein the moving contact is provided with a first contact surface and two second contact surfaces of arched shape at two sides of the first contact surface; wherein the fixed contact is provided with a third contact surface with at least two protruding portions formed thereon, the at least two protruding portions of the fixed contact is in contact with the first contact surface of the moving contact; wherein the pressing part is provided with an inclined surface corresponding to the second contact surfaces of the moving contact, when the pressing part is pressed to move downwardly, the inclined surface of the pressing part acts on the second contact surfaces of the moving contact and pushes the moving contact away from the fixed contact to cause the at least two protruding portions of the third contact surface of the fixed contact to separate from the first contact surface of the moving contact.

13. A keyboard switch comprising a top cover, a pressing part, a spring, a bottom base, a fixed contact and a moving contact;
wherein the moving contact is installed on the bottom base and a weld leg of the moving contact is extended through the bottom base; the fixed contact is installed on the bottom base and a weld leg of the fixed contact is extended through the bottom base; the moving contact and the fixed contact are disposed at opposing positions;
wherein one end of the spring is in contact with the bottom base, and the other end of the spring is in contact with the pressing part; one opening is defined in the top cover; the pressing part is extended through the opening of the top cover; the top cover is assembled to the bottom base;
wherein the top cover is provided with a light guide pillar, the bottom base is provided with a receiving hole, the light guide pillar is located above and in alignment with the receiving hole, the receiving hole is used to receive a light source therein.

14. The keyboard switch according to claim 13, wherein the light guide pillar is integrally formed with the top cover.

15. The keyboard switch according to claim 13, wherein the light guide pillar and the top cover are separate detachable structures.

16. The keyboard switch according to claim 15, wherein the top cover is provided with an insertion groove, the light guide pillar is inserted into and secured in the insertion groove.

17. The keyboard switch according to claim 13, wherein the light guide pillar is made of transparent material.

18. The keyboard switch according to claim 13, wherein the moving contact is provided with a first contact surface and two second contact surfaces of arched shape at two sides of the first contact surface; wherein the fixed contact is provided with a third contact surface with at least two protruding portions formed thereon, the at least two protruding portions of the fixed contact is in contact with the first contact surface of the moving contact; wherein the pressing part is provided with an inclined surface corresponding to the second contact surfaces of the moving contact, when the pressing part is pressed to move downwardly, the inclined surface of the pressing part acts on the second contact surfaces of the moving contact and pushes the moving contact away from the fixed contact to cause the at least two protruding portions of the third contact surface of the fixed contact to separate from the first contact surface of the moving contact.

19. The keyboard switch according to claim 13, further comprising a light source received in the receiving hole of the bottom base, the light guide pillar is used to guide and distribute light emitted from the light source.

20. The keyboard switch according to claim 19, further comprising a circuit board arranged under the bottom base, the light source is arranged on the circuit board.
